(19) United States
(12) Patent Application Publication
(10) Pub. No.: US 2026/0008436 A1
(43) Pub. Date: Jan. 8, 2026

(54) WINDSHIELD WIPER BLADE ADAPTER AND WIPING SYSTEM

(71) Applicant: VALEO SYSTEMES D'ESSUYAGE, La Verriere (FR)

(72) Inventors: Vincent GAUCHER, La Verriere (FR); Stephane HOUSSAT, La Verriere (FR); Olivier JOMARD, La Verriere (FR)

(73) Assignee: VALEO SYSTEMES D'ESSUYAGE, La Verriere (FR)

(21) Appl. No.: 18/876,733

(22) PCT Filed: Jun. 19, 2023
(86) PCT No.: PCT/EP2023/066513

§ 371 Date: Sep. 5, 2025

(30) Foreign Application Priority Data
Jun. 23, 2022 (FR) 2206232

(51) Int. Cl. B60S 1/40; B60S 1/38

(52) U.S. Cl. CPC B60S 1/4087; B60S 1/3849

(57) ABSTRACT

Disclosed is an adapter for a windshield wiper blade, configured to allow a wiper blade to be mounted on a wiper arm, the adapter including an arm through-housing configured to receive one end of the wiper arm such that the wiper arm can slide in a longitudinal direction, and a locking button configured to prevent the wiper arm in a rest position from being retracted in the longitudinal direction. The adapter also includes at least one longitudinal stop that protrudes in the arm housing and is configured to cooperate with a mating surface formed in a section of the wiper arm in order to prevent the wiper arm from being longitudinally inserted into the arm housing.

### TECHNICAL FIELD

The present invention relates to an adapter for a wiper blade configured to be able to assemble a wiper blade to a wiper arm intended to be connected to a motorized wiper mechanism of a vehicle. Another subject of the invention is a wiping device comprising a wiper arm and a wiper blade connected to said arm by means of said adapter.

### BACKGROUND OF THE INVENTION

Motor vehicles are commonly equipped with wiper systems that are intended to clean their glazed surfaces, and notably their windshield. Such wiper systems comprise a wiper arm and a wiper blade driven by said arm. The wiper arm is connected to an electric motor of the vehicle and the wiper blade comprises at least one wiper rubber adapted to come into contact with the glazed surface to be wiped. In order to be able to drive the wiper blade, an adapter is arranged between the wiper arm and a connector of the blade.

There are various kinds of arms, such as for example hook arms, arms with a lateral pivot pin, arms with longitudinal clip-fastening, rod arms, etc.

An adapter is thus specifically configured to cooperate with a rod arm. Rod arms are flat and have the advantage of being compact as a result of their small thickness.

An assembly is known in which the rod arm is inserted in a sliding manner into a housing of the adapter. In use, the withdrawal of the arm by longitudinal movement is prevented in a locking zone of the adapter as a result of releasing a push button that engages in a dedicated lateral cutout of the arm.

The mounting is realized without the user acting on the push button, which retracts during the passage of the corresponding interface of the arm. The push button then automatically assumes its locked position when the locking stud that it has is released in the lateral cutout of the arm. However, this mounting is only possible when the structure of the blade is pivoted into front abutment beneath the adapter, in other words with an open angle between the rear of the blade and the arm. Conversely, during the removal phase, it is necessary to press the push button so as to unlock it while at the same time tilting the structure of the blade at the same angle so as to make the adapter slide along the arm and freely withdraw the blade.

However, in some devices, the housing of the adapter passes all the way through and does not have this front stop. There is therefore a risk that the user will push the arm too far into the adapter, and that the lateral cutout of the arm will extend beyond the locking zone of the adapter. This extension may not allow the successive correct locking of the arm with the adapter, and may even cause damage to or even breakage of the button.

### SUMMARY OF THE INVENTION

One of the aims of the present invention is to propose an adapter that at least partially solves a drawback of the prior art.

To this end, one subject of the invention is an adapter for a wiper blade, configured to be able to assemble a wiper blade to a wiper arm, the adapter having:
an arm through-housing configured to receive an end of the wiper arm by sliding in a longitudinal direction, and
a locking button configured to block the withdrawal of the wiper arm in the longitudinal direction in a rest position, wherein the adapter also has at least one longitudinal stop arranged projecting into the housing of the arm and configured to cooperate with a complementary surface formed in an edge face of the wiper arm so as to block the longitudinal insertion of the wiper arm into the housing of the arm.

The longitudinal stop of the adapter creates a limit for the translational movement of the wiper arm via pressure during the insertion of the arm into the adapter in order to ensure the integrity of the adapter. Once the insertion of the arm into the adapter has been solidified by the cooperation of the longitudinal stop of the adapter with the complementary surface of the arm, the user can lock the blocking of the arm without risk of damage due to the blocking member. The adapter thus offers effective and reliable locking of the arm via a relatively simple means.

The adapter can also have one or more of the features that are described below, taken alone or in combination.

The longitudinal stop is for example arranged in a blocking volume of the housing of the arm, interposed between an entry cage and an end gutter of the housing of the arm, the blocking volume receiving a blocking member of the locking button in the rest position.

The longitudinal stop is for example formed in a protuberance of the adapter, arranged on the back of a wall of a connector housing configured to connect the adapter to a connector of the wiper blade.

According to a first exemplary embodiment, the longitudinal stop is formed by a transverse flat wall.

The transverse flat wall may be provided in a right-angled corner of a protuberance of the adapter.

According to a second exemplary embodiment, the longitudinal stop is formed by a first plane that is inclined with respect to a transverse plane.

The first inclined plane may be provided in an obtuse-angled corner of a protuberance of the housing of the arm.

The obtuse angle may be between 110° and 160°, such as between 125° and 145°.

The first inclined plane is for example provided in an acute-angled corner of a protuberance of the adapter.

The acute angle may be between 20° and 70°, such as between 35° and 55°.

The corner is for example formed on the one hand by the longitudinal stop and on the other hand by a second plane that is inclined with respect to a vertical plane.

Another subject of the invention is a wiping device comprising a wiper arm, in particular a rod-arm, and a wiper blade, wherein it comprises an adapter as described above, for connecting the wiper blade to the end of the wiper arm.

### BRIEF DESCRIPTION OF DRAWINGS

Other advantages and features will become apparent on studying the following description of a particular, but in no way limiting, embodiment of the invention, and also the appended drawings, in which:

FIG. 1A is a perspective view of a wiping device.

FIG. 1B is a view of a detail of the wiping device in FIG. 1A.

FIG. 2 shows one end of the arm assembled to the adapter of the wiping device in FIG. 1A.

FIG. 3A shows a bottom view of the assembly in FIG. 2.

FIG. 3B shows the assembly in FIG. 3A from another angle.

FIG. 3C shows a front view of the assembly in FIG. 3A.

FIG. 3D shows a perspective view of the end of the arm of the assembly in FIG. 3A.

FIG. 3E shows a perspective view of the adapter of the assembly in FIG. 3A.

FIG. 3F shows an enlarged view of a detail of the adapter in FIG. 3E.

FIG. 4A shows a bottom view of a second exemplary embodiment of an arm and adapter assembly.

FIG. 4B shows a perspective view of the end of the arm in FIG. 4A.

FIG. 4C shows a perspective view of a detail of the adapter in FIG. 4A.

FIG. 5A shows a bottom view of a third exemplary embodiment of an arm and adapter assembly.

FIG. 5B shows a perspective view of the end of the arm in FIG. 5A.

FIG. 5C shows a perspective view of a detail of the adapter in FIG. 5A.

In these figures, identical elements bear the same reference numerals.

### DETAILED DESCRIPTION OF THE INVENTION

The following embodiments are examples. Although the description refers to one or more embodiments, this does not necessarily mean that each reference relates to the same embodiment, or that the features apply only to a single embodiment. Individual features of different embodiments can also be combined or interchanged to provide other embodiments.

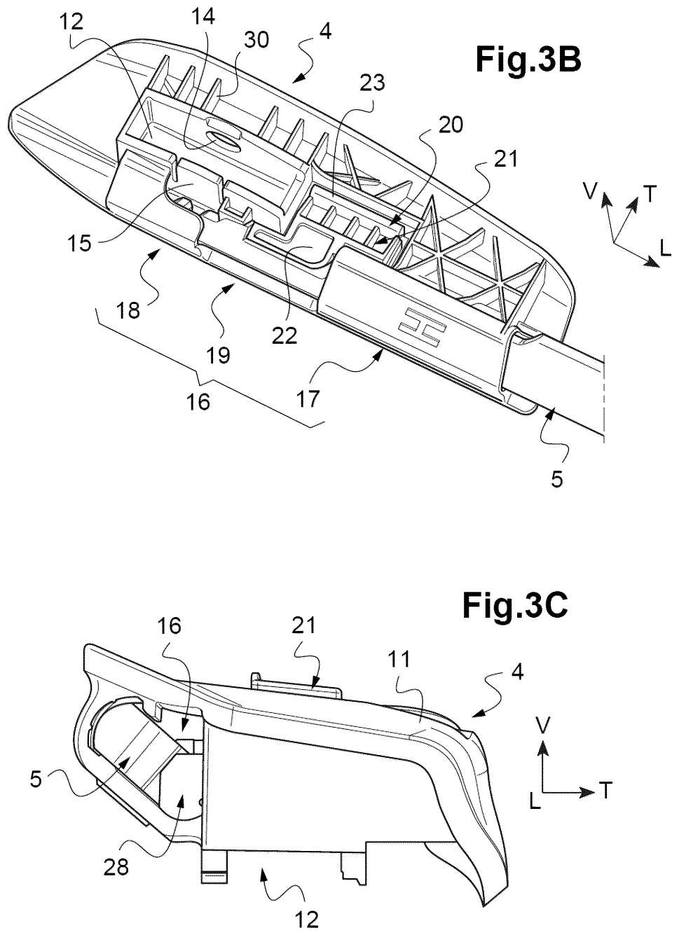

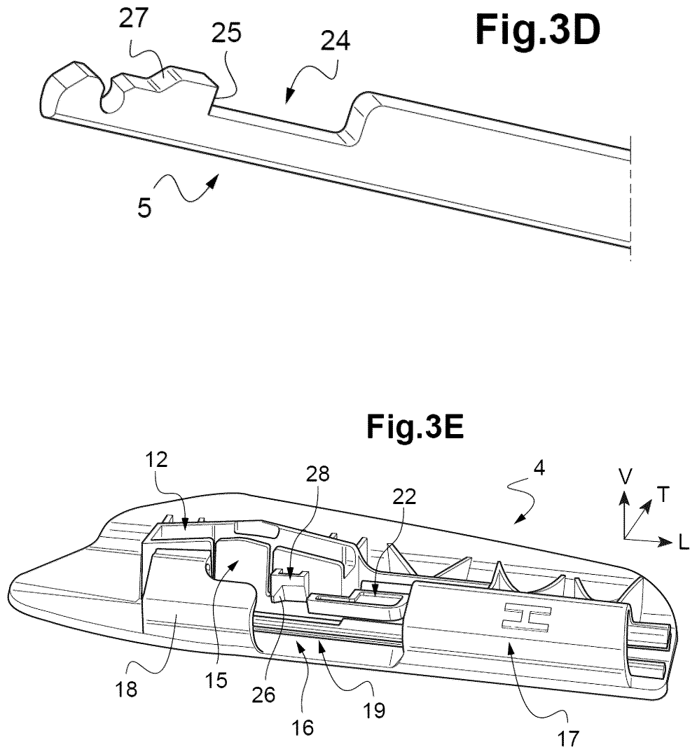

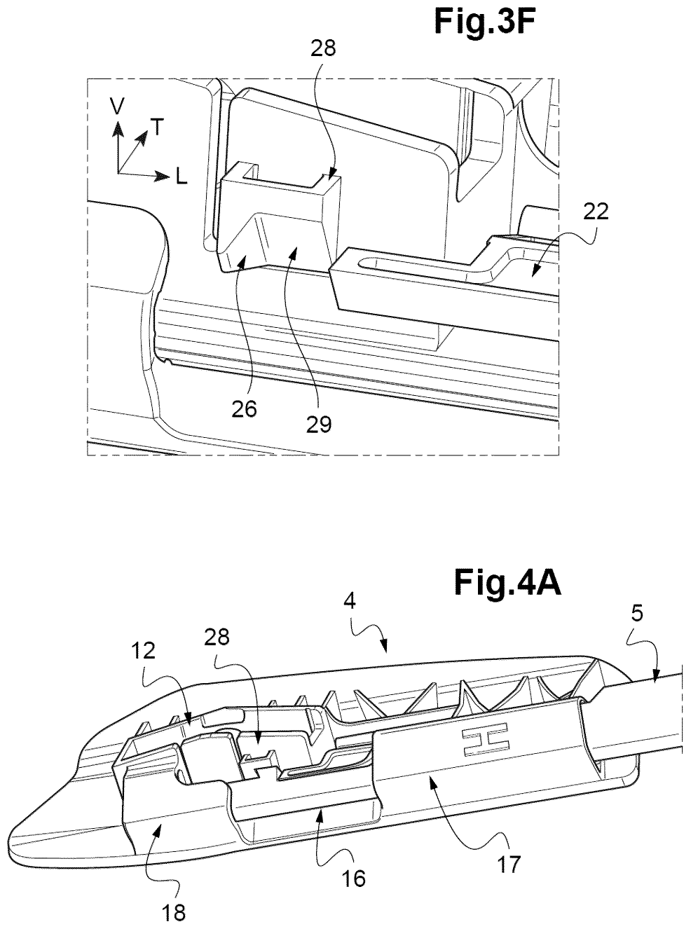

In the remainder of the description, longitudinal, vertical and transverse directions indicated in particular in FIG. 3A, FIG. 3B, FIG. 3C by the trihedron (L, V, T) that is fixed with respect to the adapter will be adopted in a non-limiting manner. The longitudinal direction L corresponds to the main direction of the end of the wiper arm cooperating with the adapter. The vertical and transverse directions are perpendicular to the longitudinal direction and perpendicular to each other.

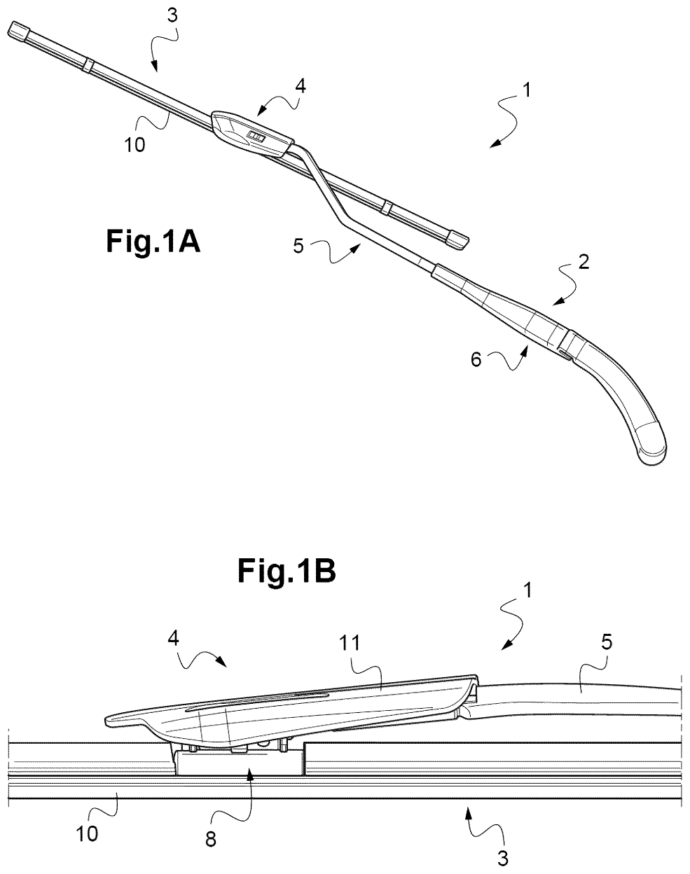

FIG. 1A and FIG. 1B show a wiping device 1 comprising a wiper arm 2 intended to be connected to a motorized wiper mechanism of a vehicle and of which the end is connected to a wiper blade 3 by means of an adapter 4, so as to clean a glazed surface of the vehicle, for example a windshield.

The arm 2 is of the rod-arm type, it comprises a rod 5 connected to a base 6 of the arm 2, which is itself intended to be connected to the motorized mechanism. The rod 5 extends between an end connected to the base 6 and an end cooperating with the adapter 4 for connection to the blade 3. The term “rod” is understood to mean a solid element of which the end extends in the longitudinal direction L (FIG. 3A, FIG. 3B, FIG. 3C). The rod 5 is “flat”, i.e. it has two faces that are flat and parallel to each other.

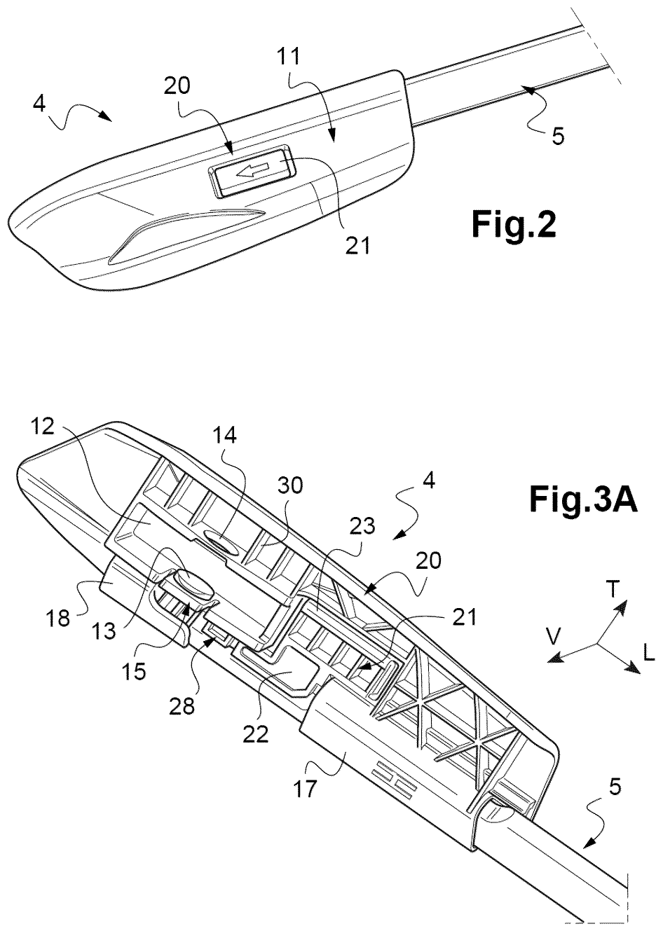

As can be seen more particularly in FIG. 1B and FIG. 2, the adapter 4 extends mainly along the longitudinal direction L. It comprises an upper wall 11 that has for example a smooth and curved profile, this wall being the one that is visible when the wiping device 1 is mounted on a vehicle.

On the back of this upper wall 11, and as can be seen in FIG. 3A and FIG. 3B, the adapter 4 has elements that make it possible on the one hand to lock the arm 2 to the adapter 4 and on the other hand to assemble the wiper blade 3 to the wiper arm 2 in an articulated manner.

In order to connect the adapter 4 to the blade 3, the adapter 4 has a connector housing 12 configured to cooperate with a connector 8 of the wiper blade 3. The connector 8 is an element of the blade 3 surmounting a wiper rubber 10 of the blade 3 in the middle thereof FIG. 1B.

The rotation between the adapter 4 and the connector 8 is realized about an axis of rotation parallel to the transverse direction T.

According to one exemplary embodiment of the complementary rotation members, the adapter 4 comprises on the one hand a cylindrical stud 13 configured to cooperate with a circular orifice of the connector 8, and on the other hand a circular hole 14 intended to cooperate with a cylindrical stud of the connector 8, the cylindrical stud 13 and the circular hole 14 being formed in parallel and opposite walls of the connector housing 12 (FIG. 3A). The cylindrical stud 13 may be formed in an elastically deformable tongue 15 provided in a wall of the connector housing 12, so as to allow the adapter 4 to be mounted on the connector 8.

In order to receive the end of the arm 2 connecting the arm 2 to the adapter 4, the adapter 4 has a housing of the arm 16 situated on one side of the adapter 4 on the back of the upper wall 11 (FIG. 3B and FIG. 3C).

The housing of the arm 16 passes all the way through in the longitudinal direction L and is configured to receive an end of the wiper arm 2 by sliding in a longitudinal direction L. The housing of the arm 16 has an entry cage 17 and an end gutter 18 that are aligned in the longitudinal direction but at a distance from one another such that the rod 5 of the arm 2 can be received in the entry cage 17 and the end gutter 18, passing through a blocking volume 19 interposed between the two. The entry cage 17 and the end gutter 18 pass all the way through. The entry cage 17 is longer in the longitudinal direction than the end gutter 18 that receives the end of the arm 2. The entry cage 17 and the end gutter 18 make it possible to guide and hold the rod 5 of the arm 2 in the adapter 4. The housing of the arm 16 allows for example the rod 5 to be held in an inclined position with respect to the vertical direction V, the parallel faces of the rod 5 being inclined by an angle for example of between 40° and 60°, such as 45°, with the vertical plane (L, V) of the adapter 4.

The adapter 4 also comprises a locking button 20 mounted so as to pivot with respect to the upper wall 11 between a rest position in which it blocks the withdrawal of the arm 2 in the longitudinal direction L and an unlocking position in which it unlocks the longitudinal movement of the arm 2 (FIG. 2).

For this purpose, the locking button 20 has an activation pad 21 on the upper wall 11 side, on which a user can press in order to pivot the locking button 20 into the unlocking position so as to be able to withdraw the arm 2, and a blocking member 22 as one with the activation pad 21 and situated on the back of the latter.

The activation pad 21 has for example a parallelepipedal shape. The top of the activation pad 21 may extend beyond the profile of the upper wall 11 (FIG. 3C). It is connected to the upper wall 11 for example by a hinge 23 on one of the sides of the activation pad 21 so as to allow the locking button 20 to pivot. The hinge 23 has for example a cross section in the shape of a “U” extending beneath the upper wall 11 (FIG. 3A and FIG. 3B).

In the rest position, the blocking member 22 is configured to block the longitudinal withdrawal of the arm 2 received in the housing of the arm 16. For this purpose, the blocking member 22 extends beyond the activation pad 21 into the housing of the arm 16, on the opposite side from the hinge 23 of the activation pad 21, into the blocking volume 19 situated between the entry cage 17 and the end gutter 18. The blocking member 22 has for example an “L” shape of which one branch is as one with the activation pad 21 and the other branch bears a projecting finger. This other branch is received in a notch 24 of the arm 2 in the rest position.

The notch 24 of the arm 2 has for example a parallelepipedal shape forming a lateral discontinuity in the edge face of the arm 2 (FIG. 3D).

In the rest position, the finger of the blocking member 22 projects toward the end of the arm 2, in contact with a transverse surface 25 of the notch 24, on the side of the end of the arm 2 of the notch 24, so as to prevent the withdrawal of the arm 2 in the longitudinal direction.

The blocking member 22 is configured to unlock the longitudinal movement of the arm 2 in the unlocking position, i.e. when the user presses on the activation pad 21. The pivoting of the activation pad 21 moves the blocking member 22 away from the transverse surface 25 of the notch 24, and this makes it possible to withdraw the arm 2 in the longitudinal direction.

The adapter 4 further comprises reinforcing walls 30 extending beneath the upper wall 11, in a vertical plane, so as to reinforce the stiffness of the adapter 4.

The adapter 4 also has at least one longitudinal stop 26 arranged projecting into the housing of the arm 16 and configured to cooperate with a complementary surface 27 formed in an edge face of the wiper arm 2 so as to block the longitudinal insertion of the wiper arm 2 into the housing of the arm 16 (FIG. 3E and FIG. 3F).

The longitudinal stop 26 is for example arranged in the blocking volume 19 of the housing of the arm 16, interposed between the entry cage 17 and the end gutter 18, the blocking volume 19 receiving the blocking member 22 in the rest position.

The longitudinal stop 26 may be formed in a protuberance 28 of the adapter 4, projecting into the housing of the arm 16, and in particular into the blocking volume 19.

The protuberance 28 is for example arranged on the back of a wall of the connector housing 12 configured to connect the adapter 4 to the blade 3. This may be the wall of the connector housing 12 in which the tongue 15 bearing the cylindrical stud 13 is provided. The protuberance 28 is situated for example next to the finger of the blocking member 22 in the longitudinal direction, in the rest position.

The complementary surface 27 of the arm 2 is formed in the edge face of the rod 5, for example between the end of the arm 2 and the transverse surface 25 of the notch 24 cooperating with the finger of the blocking member 22 (FIG. 3D).

In the first exemplary embodiment, in FIGS. 3A to 3F, the longitudinal stop 26 is formed by a first plane that is inclined with respect to a transverse plane (V, T). The first inclined plane is, in other words, a transverse plane that has pivoted about a vertical rotation angle (FIG. 3E and FIG. 3F). The complementary surface 27 borne by the edge face of the rod 5 is also formed by an inclined plane (FIG. 3D).

Furthermore, in the first exemplary embodiment, the inclined plane is provided in an obtuse-angled corner of the protuberance 28 of the adapter 4.

According to one exemplary embodiment, the corner is formed on the one hand by the longitudinal stop 26 and on the other hand by a second plane 29 that is inclined with respect to a vertical plane (V, L). The second inclined plane 29 is, in other words, a vertical plane that has pivoted about a longitudinal rotation angle. This second inclined plane 29 allows the rod 5 to be guided into a position that is inclined with respect to the vertical.

The obtuse angle is for example between 110° and 160°, such as between 125° and 145°.

The longitudinal stop 26 of the adapter 4 creates a limit for the translational movement of the rod 5 of the wiper arm 2 via pressure during the insertion of the arm 2 into the adapter 4 in order to ensure the integrity of the adapter 4. Once the insertion of the arm 2 into the adapter 4 has been solidified by the cooperation of the longitudinal stop 26 of the adapter 4 with the complementary surface 27 of the arm 2, the user can lock the blocking of the arm 2 without risk of damage due to the blocking member 22. The adapter 4 thus offers effective and reliable locking of the arm 2 via a relatively simple means.

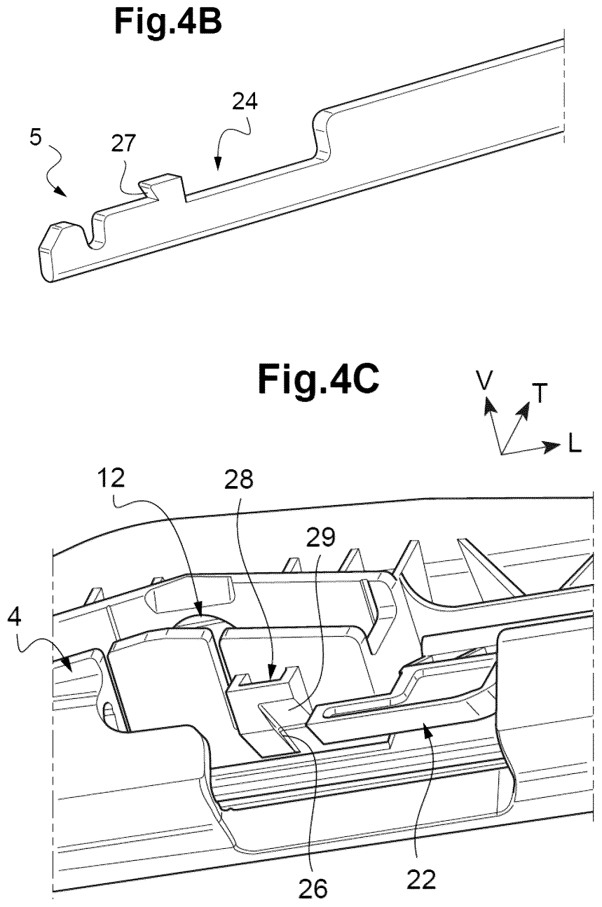

FIG. 4A, FIG. 4B and FIG. 4C show a second exemplary embodiment.

This example differs from the previous one by the fact that in this example the first inclined plane is provided in an acute-angled corner of the protuberance 28 of the adapter 4.

The corner may also be formed on the one hand by the longitudinal stop 26 and on the other hand by a second plane 29 that is inclined with respect to a vertical plane (V, L), i.e. a vertical plane that has pivoted about a longitudinal rotation angle.

The acute angle is for example between 20° and 70°, such as between 35° and 55°.

The other elements of the wiping device of this second exemplary embodiment

are the same as for the first exemplary embodiment.

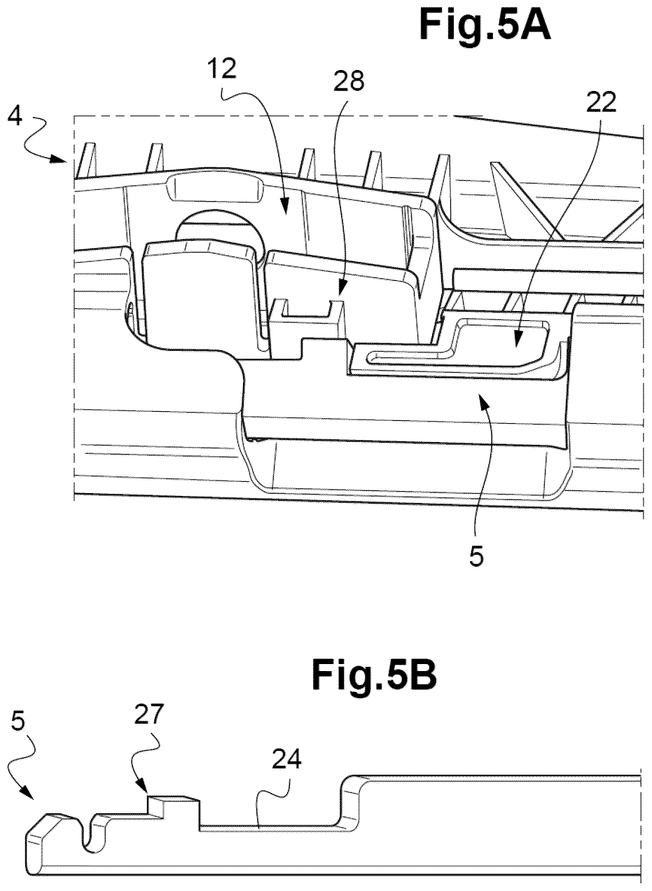

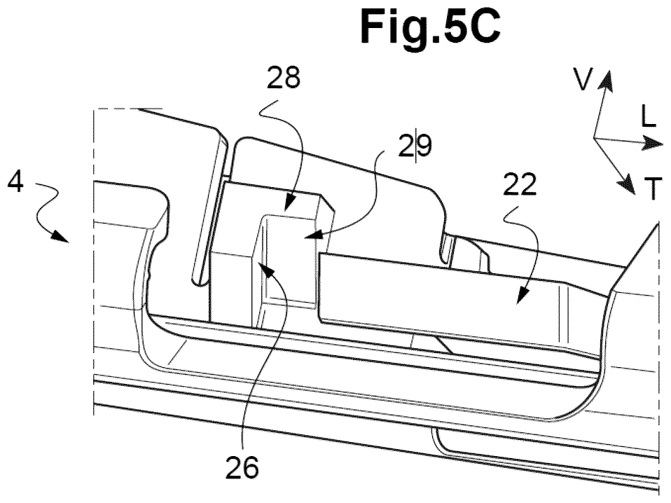

In the third exemplary embodiment, in FIG. 5A, FIG. 5B and FIG. 5C, the longitudinal stop 26 is formed by a transverse flat wall (T, V) (FIG. 5A and FIG. 5C). The complementary surface 27 borne by the edge face of the rod 5 is also formed by a transverse flat wall (T, V) (FIG. 5B).

The transverse flat wall (T, V) may be provided in a right-angled corner of the protuberance 28 of the adapter 4. The corner may be formed on the one hand by the longitudinal stop 26 and on the other hand by a second plane 29 that is inclined with respect to a vertical plane (V, L).

The other elements of the wiping device of this second exemplary embodiment are the same as for the preceding exemplary embodiments.

What is claimed is:

1. An adapter for a wiper blade, configured to be able to assemble a wiper blade to a wiper arm, the adapter comprising:
an arm through-housing configured to receive an end of the wiper arm by sliding in a longitudinal direction and
a locking button configured to block the withdrawal of the wiper arm in the longitudinal direction in a rest position,
wherein the adapter also has at least one longitudinal stop arranged projecting into the housing of the arm and configured to cooperate with a complementary surface formed in an edge face of the wiper arm so as to block the longitudinal insertion of the wiper arm into the housing of the arm.

2. The adapter as claimed in claim 1, wherein the longitudinal stop is arranged in a blocking volume of the housing of the arm, interposed between an entry cage and an end gutter of the housing of the arm, the blocking volume receiving a blocking member of the locking button in the rest position.

3. The adapter as claimed in claim 1, wherein the longitudinal stop is formed in a protuberance of the axis adapter, arranged on the back of a wall of a connector housing configured to connect the adapter to a connector of the wiper blade.

4. The adapter as claimed in claim 1, wherein the longitudinal stop is formed by a transverse flat wall.

5. The adapter as claimed in claim 4, wherein the transverse flat wall is provided in a right-angled corner of a protuberance of the adapter.

6. The adapter as claimed in claim 1, wherein the longitudinal stop is formed by a first plane that is inclined with respect to a transverse plane.

7. The adapter as claimed in claim 6, wherein the first inclined plane is provided in an obtuse-angled corner of a protuberance of the housing of the arm.

8. The adapter as claimed in claim 6, wherein the first inclined plane is provided in an acute-angled corner of a protuberance of the adapter.

9. The adapter as claimed in claim 5, wherein the corner is formed on the one hand by the longitudinal stop and on the other hand by a second plane that is inclined with respect to a vertical plane.

10. A wiping device comprising a wiper arm, the wiper arm being a rod-arm, and a wiper blade, wherein the wiper blade includes an adapter for connecting the wiper blade to the end of the wiper arm, with the adapter including an arm through-housing configured to receive an end of the wiper arm by sliding in a longitudinal direction and a locking button configured to block the withdrawal of the wiper arm in the longitudinal direction in a rest position, wherein the adapter also has at least one longitudinal stop arranged projecting into the housing of the arm and configured to cooperate with a complementary surface formed in an edge face of the wiper arm so as to block the longitudinal insertion of the wiper arm into the housing of the arm.
